(19) United States
(12) Patent Application Publication
(10) Pub. No.: US 2022/0184644 A1
(43) Pub. Date: Jun. 16, 2022

(54) Unknown

(71) Applicant: SKINJAY, Paris (FR)

(72) Inventors: Nicolas PASQUIER, Lyon (FR); Luc MAUGENET, Villars-les-Dombes (FR)

(73) Assignee: SKINJAY, Paris (FR)

(21) Appl. No.: 17/582,379

(22) Filed: Jan. 24, 2022

Related U.S. Application Data
(63) Continuation of application No. PCT/FR2021/051362, filed on Jul. 21, 2021.

(30) Foreign Application Priority Data
Jul. 27, 2020 (FR) 20/07920

(51) Int. Cl. B05B 1/18; B05B 15/652

(52) U.S. Cl. CPC B05B 1/185; B05B 15/652

(57) ABSTRACT

The invention relates to a water distribution device for a shower installation. The distribution device is of the hand-held shower head type or of the overhead shower head type. The distribution device includes a distribution head configured to be connected to a water supply line. The head includes a first group of water ejection nozzles arranged on a first face of the head, and a second group of water ejection nozzles arranged on a second face of the head. The second group of nozzles is oriented so that when the distribution device is in a position of use allowing a jet of water expelled by the first group of nozzles to be oriented downwards and forwards, the jet of water expelled by the second group of nozzles is oriented upwards and forwards, so as to generate a bell-shaped jet.

### CROSS-REFERENCE TO RELATED APPLICATIONS

This application is a continuation of International Application No. PCT/FR2021/051362, filed on Jul. 21, 2021, which claims priority to and the benefit of FR 20/07920 filed on Jul. 27, 2020. The disclosures of the above applications are incorporated herein by reference.

### FIELD

The present disclosure relates to the field of bathroom equipment and accessories, and more particularly to the field of fittings. The invention relates more specifically to a water distribution device for a shower installation, such as a hand-held shower head or an overhead shower head.

### BACKGROUND

The statements in this section merely provide background information related to the present disclosure and may not constitute prior art.

In addition to the conventional shower head, so-called hand-held shower rose or head, there are several types of devices available on the market with the aim of increasing the diversity of the water jets obtained.

For example, shower heads are known which make it possible to obtain a jet of the “rain effect” type, the jet of water being oriented vertically, downwards, and expelled with a low or zero pressure, so as to simulate the effect of a rain. Such a device, generally referred to as a shower head or overhead shower, is generally recessed in the ceiling of the shower. In this type of installation, the piping is generally concealed in the ceiling and in the walls, which requires relatively heavy and therefore costly work during assembly. The device can also be fixed to a wall, by means of fixing bars integral with the wall, but this again requires relatively significant installation work.

### SUMMARY

This section provides a general summary of the disclosure and is not a comprehensive disclosure of its full scope or all of its features.

The present invention aims to remedy the drawbacks of the state of the art, in particular those described above, by proposing a water distribution device with a rain effect function which can be installed without major work, and which is therefore economical for the user.

To this end, the invention relates to a water distribution device for a shower installation, the distribution device being of the hand-held shower head type or of the overhead shower head type, the distribution device comprising a distribution head configured to be connected to a water supply line, the head comprising:

a first group of water ejection nozzles arranged on a first face of the head;

a second group of water ejection nozzles arranged on a second face of the head, the second group of nozzles being oriented so that, when the distribution device is in a position of use allowing a jet of water expelled by the first group of nozzles to be oriented downwards and forwards, the jet of water expelled by the second group of nozzles is oriented upwards and forwards, so as to generate a bell-shaped jet.

Thus, by providing two distinct groups of nozzles, one of which is oriented so that the flow of water ejected is oriented upwards and forwards so as to form a bell-shaped jet, the water distribution device according to the invention makes it possible to obtain a rain effect in a simple and inexpensive way. In particular, if the device is of the hand-held shower head type, it is simply necessary to change the existing shower head, without tampering with the piping. If it is a device of the overhead shower head type, its installation does not require any work if it is intended to replace an overhead shower head previously installed. The distribution device according to the invention therefore allows a user to benefit from top-of-the-range services, normally accessible with significantly more expensive installations, in particular because of the major plumbing and masonry work that they require. In addition, the device according to the invention makes it possible to provide, by means of a single compact accessory, a set of services which, in the state of the art, require several distinct elements.

In one embodiment, the first group of nozzles is oriented so as to generate a jet of water having an initial shape which is generally symmetrical with respect to a first axis, the second group of nozzles being oriented so as to generate a jet of water having an initial shape which is generally symmetrical with respect to a second axis, the second axis forming with the first axis an angle between 30° and 150°.

In one embodiment, the second group of nozzles comprises nozzles of different orientations and/or shapes and/or outlet diameters depending on their position within the second group of nozzles, so that the trajectories of the elementary jets generated by each of the nozzles do not intersect when the distribution device is in a position of use.

In one embodiment, at least a part of the nozzles of the second group of nozzles is orientable.

Thanks to a second group of nozzles of which at least part of the nozzles is orientable, a user can easily modify the distance at which the bell-shaped jet will fall, which makes it possible in particular to make the distribution device conform to the invention even more easily adaptable to any pre-existing shower installation.

In one embodiment, the nozzles of the second group of nozzles are arranged on a support, the support being rotatable relative to the head.

In one embodiment, the head comprises a housing in which the support for the second group of nozzles is mounted, the housing being rotatable relative to the rest of the head.

In one embodiment, the head comprises a housing in which the support for the second group of nozzles is mounted, the housing being fixed relative to the rest of the head, the support being rotatable relative to the housing.

In one embodiment, the nozzles of the second group of nozzles are arranged on a support, the support being fixed relative to the rest of the head, the distribution device comprising an actuation mechanism making it possible to modify the orientation and/or the shape of at least a part of the nozzles.

In one embodiment, the actuation mechanism comprises a sliding element connected by a link to each of the nozzles whose orientation can be modified, the displacement of the sliding element modifying the orientation of said nozzles.

In one embodiment, the actuation mechanism comprises a control element allowing a user to control the movement of the sliding element.

In one embodiment, at least part of the nozzles of the second group of nozzles comprises a deformable portion, making it possible to adjust the ejection rate and/or the orientation of the ejected flow by deformation of the deformable portion by means of the actuation mechanism.

In one embodiment, the actuation mechanism comprises a movable grid, positioned so that each of the nozzles comprising a deformable portion is partially inserted into a respective orifice in the grid, the displacement of the grid being capable of modifying the shape of said nozzles and/or their orientation.

In one embodiment, the distribution device comprises an adjustment device for the nozzle outlet pressure of the flow of water ejected by the second group of nozzles, for example an adjusting knob or a multi-position selector.

In one embodiment, the device comprises a selection device making it possible to selectively direct the flow of water entering the distribution device towards the first group of nozzles or towards the second group of nozzles.

In one embodiment, the selection device also makes it possible to direct the flow of water entering the distribution device simultaneously towards the first and second groups of nozzles.

In one embodiment, the distribution device is of the hand-held shower head type, the head being integral with a body, a portion of which forms a gripping handle.

In one embodiment, the body of the distribution device comprises a third group of nozzles, arranged on the portion of the body forming the gripping handle.

In one embodiment, the distribution device comprises a selection device making it possible to selectively direct the flow of water entering the distribution device towards the first group of nozzles, or towards the second group of nozzles, or towards the third group of nozzles.

In one embodiment, the body comprises a connection device for connecting the distribution device to a supply line such as a flexible hose.

In one embodiment, the distribution device is of the overhead shower head type, and comprises a connection device to a supply line allowing the distribution device to be fixed to a wall.

In one embodiment, the distribution device comprises a diffusing device for an encapsulated product, the dispensing device being configured to diffuse a product contained in a capsule into the flow(s) of water ejected by the distribution device, the diffusing device being for example arranged in the head.

The invention also relates to a shower installation comprising a water distribution device as defined above.

Further areas of applicability will become apparent from the description provided herein. It should be understood that the description and specific examples are intended for purposes of illustration only and are not intended to limit the scope of the present disclosure.

### DRAWINGS

The present invention will be better understood on reading the following detailed description with reference to the accompanying drawings, in which:

FIG. 1 is a side view of a distribution device according to the invention, in a configuration of the hand-held shower head type;

FIG. 2 is a side view of a distribution device according to the invention, of the hand-held shower head type, comprising a second group of adjustable nozzles;

FIG. 3a shows a shower installation comprising a distribution device of the hand-held shower head type according to the invention;

FIG. 3b shows a shower installation comprising a distribution device of overhead shower head type according to the invention;

FIG. 4a is a view of the shower head in FIG. 2, the second group of nozzles being in a first position;

FIG. 4b is a view of the shower head in FIG. 2, the second group of nozzles being in a second position;

FIG. 4c is a view of the shower head in FIG. 2, the second group of nozzles being in a third position;

FIG. 5a is a view of a hand-held shower head according to the invention, the second group of nozzles of which is adjustable, the second group of nozzles being in a first position;

FIG. 5b is a view of the shower head in FIG. 5a, the second group of nozzles being in a second position;

FIG. 5c is a view of the shower head in FIG. 5a, the second group of nozzles being in a third position;

FIG. 6a is a detailed view of a part of the nozzles of the second group of nozzles, the nozzles being adjustable by means of an actuation mechanism, the nozzles being in a first position;

FIG. 6b is a view of the nozzles in FIG. 6a, the nozzles being in a second position;

FIG. 7a is a detailed view of a part of the nozzles of the second group of nozzles, the profile and/or the orientation of the nozzles being modifiable by means of an actuation mechanism, the nozzles being in a first configuration;

FIG. 7b is a view of the nozzles in FIG. 7a, the nozzles being in a second configuration;

FIG. 8a is a detailed view of a nozzle in FIG. 7a in a first configuration;

FIG. 8b is a detailed view of the nozzle in FIG. 8a, in a second configuration;

FIG. 8c is a detailed view of the nozzle in FIG. 8a, in a third configuration; and

FIG. 9 is a view of a distribution device according to the invention, in a configuration of the overhead shower head type.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

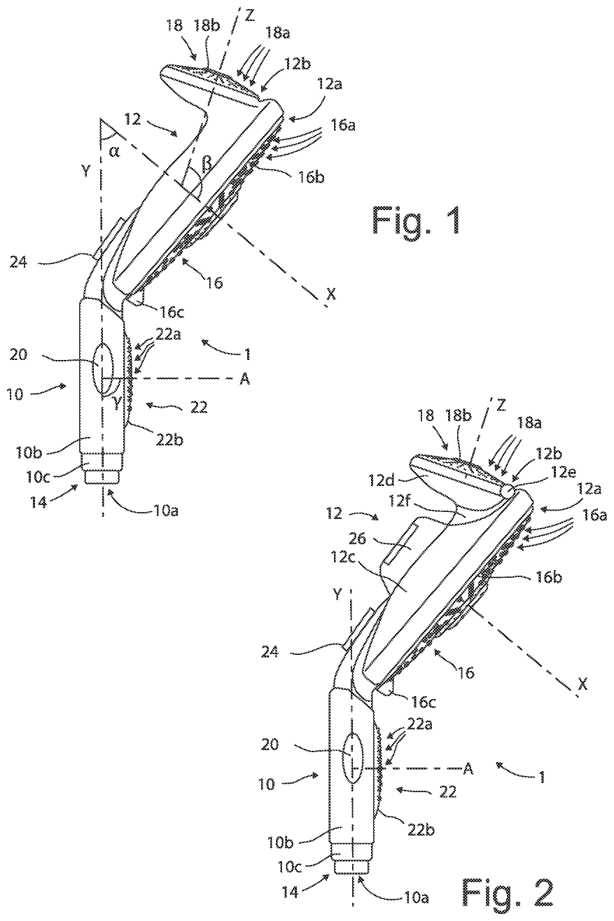

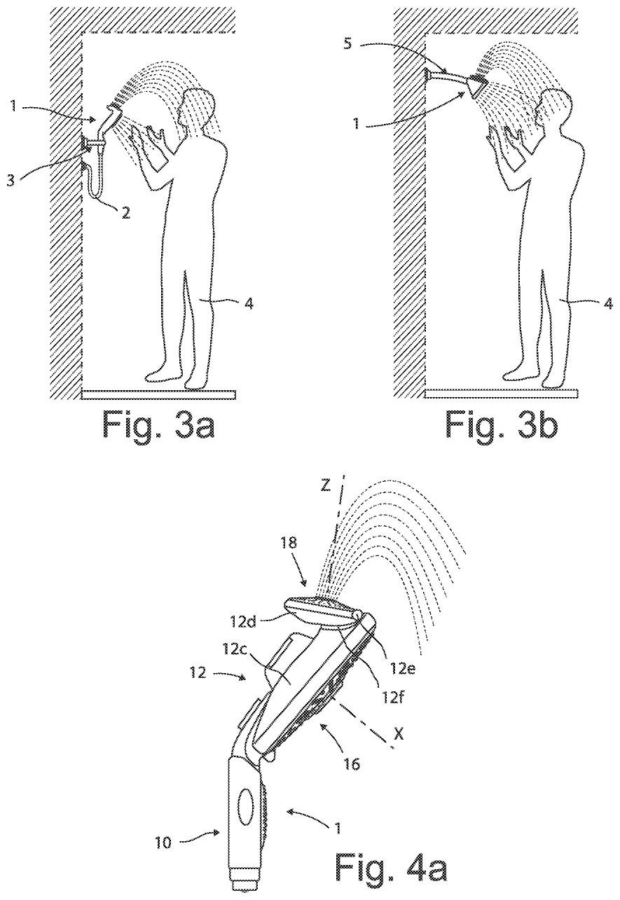

FIG. 1 is a view of a water distribution device 1 according to the invention, in the example a hand-held shower head to be connected to a flexible water supply line. The shower head 1 comprises a body 10, which in the example is elongated along a longitudinal axis Y. The body 10 is integral, at a first end, with a distribution head 12. The body 10 comprises, at a second end opposite the first end, a connection device 14 for connecting the distribution device 1 to a water supply line, and in particular to a flexible supply line such as the flexible hose 2 in FIG. 3a. The connection device 14 makes it possible to connect a water supply line to at least one internal channel 10a within the body 10, the channel(s) being configured to bring a flow of water to the different groups of nozzles of the distribution device, which are described in more detail below. A portion 10b of the body 10 forms a gripping handle. The body 10 can include, close to the first end, a fixing part 10c, allowing the fixing of the shower head 1 to a wall support, such as the wall support 3 in FIG. 3a. Alternatively, such a fixing part can be provided at one end of the flexible hose 2 to which the distribution device 1 is connected.

The head 12 of the shower head 1 comprises, on a first face 12a, a first group of nozzles 16 for ejecting a flow of water. The nozzles 16a of the first group of nozzles 16 are arranged on a support 16b having a generally flat or curved shape, the contour of which has a symmetry with respect to a first axis X. The support 16b can for example have a shape whose contour is circular, square or rectangular. Thus, when a flow of water is ejected by the nozzles 16a of the first group of nozzles 16, this flow forms a jet with a (initial) general symmetrical shape with an axis X, and in particular a conical or cylindrical shape. In the example, the first face 12a of the head 12 of the shower head 1 is oriented so that the axis X forms with the axis Y of the body 10 an angle α between 30° and 90°, and in particular between 45° and 90°.

In the example, the first group of nozzles 16 is configured so as to operate according to several operating modes, making it possible to modulate the shape of the flow of water ejected by the first group of nozzles 16. A control device 16c is provided to allow a user to select any one of the operating modes.

The head 12 of the shower head 1 comprises, on a second face 12b, a second group of nozzles 18 for ejecting a flow of water, distinct from the first group of nozzles 16. The nozzles 18a of the second group of nozzles 18 are arranged on a support 18b having a generally flat or curved shape, the contour of which has a symmetry with respect to a second axis Z. The support 18b can for example have a shape whose contour is circular, square or rectangular. Thus, when a flow of water is ejected by the nozzles 18a of the second group of nozzles 18, this flow forms a jet with a (initial) generally symmetrical shape with an axis Z, and in particular a conical or cylindrical shape. In the example, the second face 12b of the head 12 of the shower head 1 is oriented so that the axis Z forms with the axis X of the first group of nozzles 16 an angle β between 30° and 150°, and in particular between 45° and 135°. When the shower head 1 is in a position of use in which the longitudinal axis Y of the body 10 is vertical or slightly inclined with respect to the vertical direction (in particular less than 45°), the orientation of the second group of nozzles 18 allows a flow of water to be ejected upwards and forwards, and thus enables to obtain a bell-shaped jet, capable of falling on a user 4 with a rain effect, as shown in FIG. 3a. Thus, the shower head 1 is capable of generating a bell-shaped jet thanks to the second group of nozzles 18 when the head 12 is oriented so that a jet capable of being generated by the first group of nozzles 16 is oriented downwards and forwards, as seen in FIG. 3a (it will be noted that FIG. 3a, like FIG. 3b, shows jets of water generated simultaneously by the first and second groups of nozzles 16, 18, even if, as detailed below, such a configuration is not always possible, depending on the embodiments).

Preferably, the second group of nozzles 18 is configured so that the trajectories of the elementary jets generated by each of the nozzles 18a are not intersecting. Such a configuration promotes the generation, by all of the nozzles 18a of the second group of nozzles, of a bell-shaped jet within which each elementary jet is quite distinct from the others (including during fallout), which reinforces the rain effect sensation by a user. To this end, the nozzles 18a of the second group of nozzles 18 can have different orientations and/or shapes and/or outlet diameters according to their position within the second group of nozzles 18.

In order to be able to selectively activate the first or the second group of nozzles 16, 18, the shower head 1 comprises a selection device 20. The selection device 20 can be configured to activate only one group of nozzles at a time, or to allow to selectively activate any one of the two groups of nozzles 16, 18, or both groups of nozzles 16, 18 simultaneously.

In the example of FIGS. 1 and 2, the shower head 1 includes a third group of nozzles 22, arranged on the body 10 and configured to expel a flow of water so that the jet of water is oriented forwards when the body 10 is oriented so that the longitudinal axis Y is substantially vertical. In the example, the nozzles 22a of the third group of nozzles are arranged on a support 22b having a flat or curved shape, the contour of which has a symmetry with an axis A. In the example of FIGS. 1 and 2, the axis A is perpendicular to the longitudinal axis Y of the body 10, but the angle γ between these two axes can be between 45° and 135° and in particular between 45° and 90°. This third group of nozzles 22 makes it possible, for example, to obtain a jet having a massaging or misting effect. When the shower head 1 comprises three groups of nozzles 16, 18, 22, the selection device 20 makes it possible to selectively activate any one of these groups of nozzles. Alternatively, the selection device 20 can be configured so as to make it possible to selectively activate any one of the three groups of nozzles 16, 18, 22, or simultaneously two of the three groups of nozzles 16, 18, 22, or even the three groups simultaneously.

Optionally, the shower head 1 comprises an adjusting device 24 for the water pressure at the nozzle outlet of the second group of nozzles 18. The adjusting device 24, by offering an adjustment of the outlet pressure, makes it possible to vary the height of the jet of water formed by the second group of nozzles, and thus the width of the bell formed by this jet. The adjusting device 24 thus allows a user to vary the distance at which the jet of water falls. The adjusting device 24 can include an adjusting knob (with or without indexed positions), or a selector with several positions, for example two or three positions.

FIG. 2 shows a hand-held shower head 1 similar to that in FIG. 1, comprising a second group of nozzles 18 that can be oriented, in order to allow a user to adjust its orientation. The support 18b carrying the nozzles 18a of the second group of nozzles 18 is for this purpose mobile in rotation around an axis of rotation perpendicular to the axes X and Z (and therefore perpendicular to the plane of FIG. 2). In the example, the head 12 comprises a first housing 12c, receiving the first group of nozzles 16, and a second housing 12d, receiving the second group of nozzles 18. The second housing 12d is rotatable relative to the first housing 12c, via an axis of rotation 12e. In the example, a flexible and/or extensible junction element 12f is arranged between the first housing 12c and the second housing 12d, in order to compensate for the variable spacing between the two housings.

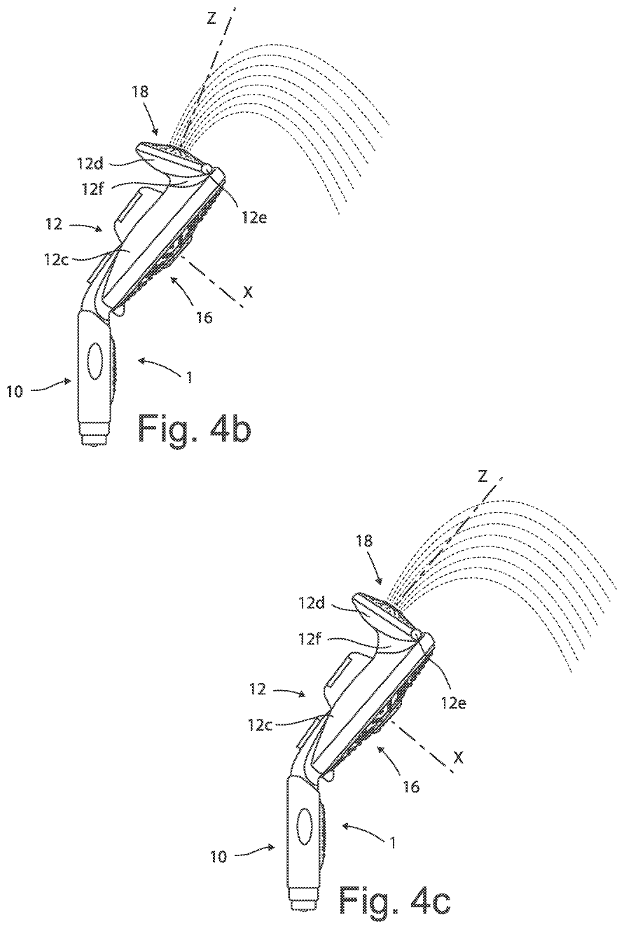

FIGS. 4a, 4b and 4c show the shower head 1 in FIG. 2 in different positions of the second housing 12d, and therefore in several configurations of the jet of water generated by the second group of nozzles 18. As visible in these figures, the modification of the orientation of the second group of nozzles 18 makes it possible to modify the shape of the jet of water, thus modifying the distance at which this bell-shaped jet falls. The user can therefore modify this distance according to his/her needs, which makes it possible in particular to make the distribution device according to the invention even more easily adaptable to any pre-existing shower installation.

Alternatively, the second housing 12d can be moved to a retracted position, a position in which it is folded back against the first housing 12c, in order to reduce the size of the shower head when the second group of nozzles 18 is not used.

In a variant, the second housing 12d can be slidably mounted on a support integral with the first housing 12c, the support having a concave or convex shape, allowing the sliding of the second housing 12d on the support to modify the orientation of the second group of nozzles 18.

As shown in FIG. 2, when the second group of nozzles 18 is adjustable, the shower head 1 can optionally include the adjusting device 24 previously described.

Optionally, the shower head 1 can include a diffusing device 26 for an encapsulated product, compatible with the use of capsules as described in document EP 2 989 260. The operation of the diffusing device 26 is preferably similar to that of the device described in document EP 2 989 260.

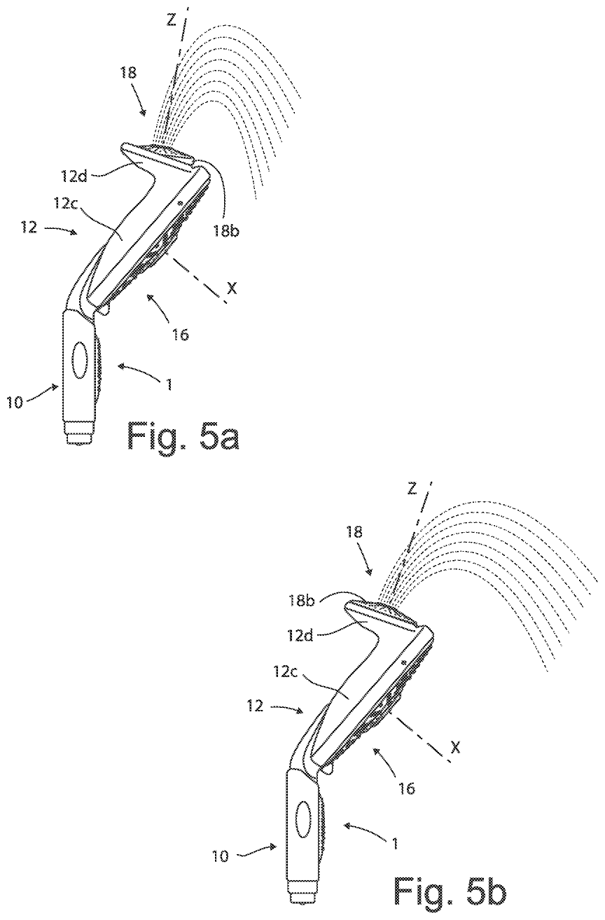

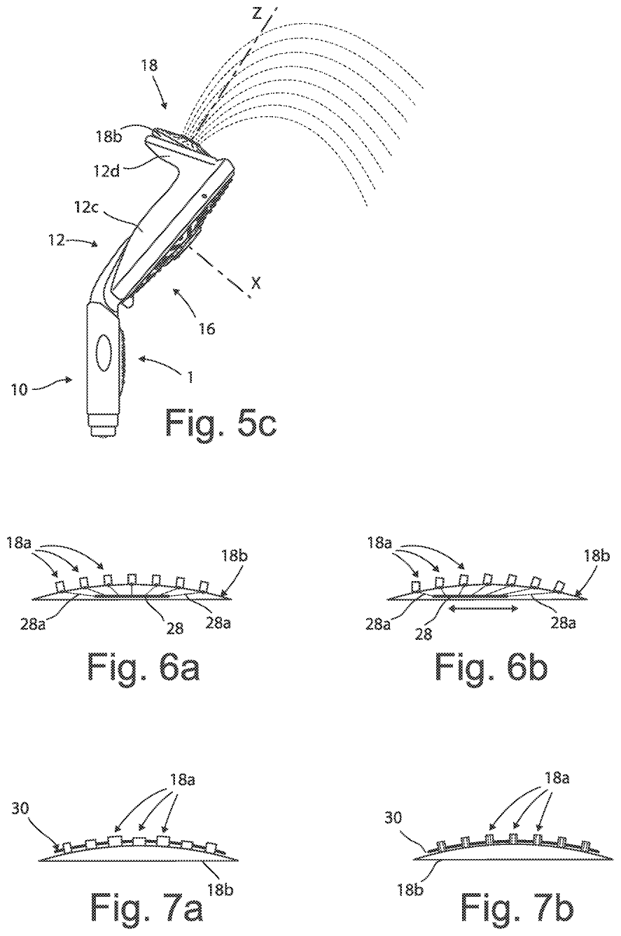

FIGS. 5a, 5b and 5c show a variant of the shower head 1 in FIG. 2. The second group of nozzles 18 is adjustable, but in the example the second housing 12d is fixed relative to the rest of the head 12. The support 18b, carrying the nozzles of the second group of nozzles 18, is rotatable relative to the second housing 12d. As visible in FIGS. 5a to 5c, the support can be tilted between several positions. To modify the position of the support 18b, and therefore the orientation of the jet generated by the second group of nozzles 18, the user can press directly on this support with his/her hand.

Alternatively, it may be provided that only part of the nozzles 18a of the second group of nozzles 18 are orientable. For example, the support 18b can comprise a central part which is mobile in rotation and a peripheral part which is fixed with respect to the head 12, or, conversely, a central fixed part and a peripheral mobile part.

Alternatively, it may be provided that the second group of nozzles 18 is orientable and arranged in the second fixed housing 12d in FIGS. 5a to 5c, the second group of nozzles 18 being slidably mounted on a fixed support relative to the second housing 12d, the support having a concave or convex shape, allowing the sliding of the second group of nozzles 18 on the support to modify its orientation.

When the second group of nozzles 18 is adjustable, its position can be indexed. Alternatively, it may be provided a device allowing a position chosen by the user to be kept without indexing.

It may also be provided that the shape and/or orientation of all or part of the nozzles 18a of the second group of nozzles 18 are modifiable by means of an actuation mechanism acting directly on each corresponding nozzle 18a. Thus, as shown in FIGS. 6a and 6b, it is possible to provide an actuation mechanism comprising a sliding element 28 whose movement between several positions modifies the orientation of at least part of the nozzles 18a, the latter being movable relative to the support 18b and each connected by a link 28a to the sliding element 28. The displacement of the sliding element 28 is controlled by the user, for example via a control lever (not shown).

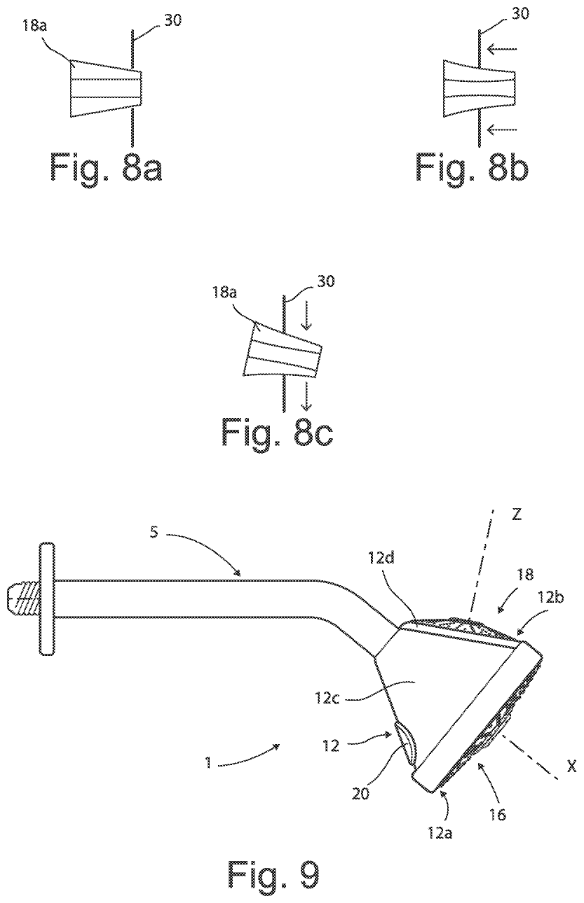

FIGS. 7a, 7b and 8a to 8c show a variant in which the actuation mechanism comprises a grid 30 cooperating with the nozzles 18a which are movable relative to the support 18b, each of these nozzles 18a partially penetrating into a corresponding orifice in the grid 30 (partially shown in FIGS. 8a to 8c). The grid 30 is movable in translation along two axes, thus making it possible to vary the orientation of the nozzles (FIG. 8c) and/or their ejection diameter (FIG. 8b).

As visible in FIGS. 3b and 9, the distribution device 1 can be of the overhead shower head type. In the example, the head 12 is fixed and connected to a water supply line via a rigid tubular arm 5. As with the device in the preceding figures, the head 12 of the distribution device 1 comprises a first group of nozzles 16 and a second group of nozzles 18, arranged respectively on a first and a second face 12a, 12b of the head 12. In the example, the head has a generally frustoconical shape. The head 12 comprises a first housing 12c including the first group of nozzles 16 and a second housing 12d including the second group of nozzles 18. All the embodiment variants of the first and second groups of nozzles described above can be adapted to the distribution device in FIG. 9. In particular, the housing 12d can be fixed or mobile relative to the rest of the head 12. As can be seen in FIG. 9, the selection device 20 is arranged on the head 12.

In an embodiment of the distribution device 1, not shown, the second group of nozzles can be oriented by modifying the orientation of the head 12, the head 12 being able to rotate relative to the body 10 in the case of a hand-held shower head, or fixed via a ball joint device in the case of an overhead shower head.

In an embodiment of the distribution device 1, not shown, the body 10 and the head 12 (or at least a part of the head 12 including the first group of nozzles 16) form a one-piece assembly of generally cylindrical shape, with a circular or polygonal base.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A water distribution device for a shower installation, the distribution device comprising a distribution head configured to be connected to a water supply line, the distribution device being of the hand-held shower head type, and the head being integral with a body, a portion of which forms a gripping handle, or the distribution device being of the overhead shower head type and comprising a connection device to a supply line allowing the distribution device to be fixed to a wall, the head comprising:
a first group of water ejection nozzles arranged on a first face of the head;
a second group of water ejection nozzles arranged on a second face of the head, the second group of nozzles being oriented so that, when the distribution device is in a position of use allowing a jet of water expelled by the first group of nozzles to be oriented downwards and forwards, the jet of water expelled by the second group of nozzles is oriented upwards and forwards, so as to generate a bell-shaped jet.

2. The distribution device according to claim 1, wherein the first group of nozzles is oriented so as to generate a jet of water having an initial shape which is generally symmetrical with respect to a first axis, the second group of nozzles being oriented so as to generate a jet of water having an initial shape which is generally symmetrical with respect to a second axis, the second axis forming with the first axis an angle between 30° and 150°.

3. The distribution device according to claim 1, wherein the second group of nozzles comprises nozzles of different orientations and/or shapes and/or outlet diameters depending on their position within the second group of nozzles, so that the trajectories of the elementary jets generated by each of the nozzles do not intersect when the distribution device is in a position of use.

4. The distribution device according to claim 1, wherein at least a part of the nozzles of the second group of nozzles is orientable.

5. The distribution device according to claim 1, wherein the nozzles of the second group of nozzles are arranged on a support, the support being rotatable relative to the head.

6. The distribution device according to claim 1, wherein the head comprises a housing in which the support of the second group of nozzles is mounted, the housing being rotatable relative to the rest of the head.

7. The distribution device according to claim 5, in which the head comprises a housing in which the support of the second group of nozzles is mounted, the housing being fixed relative to the rest of the head, the support being rotatable relative to the housing.

8. The distribution device according to claim 1, wherein the nozzles of the second group of nozzles are arranged on a support, the support being fixed relative to the rest of the head, the distribution device comprising an actuation mechanism making it possible to modify the orientation and/or the shape of at least a part of the nozzles.

9. The distribution device according to claim 8, wherein the actuation mechanism comprises a sliding element connected by a link to each of the nozzles whose orientation can be modified, the displacement of the sliding element modifying the orientation of said nozzles.

10. The distribution device according to claim 9, wherein the actuation mechanism comprises a control element allowing a user to control the movement of the sliding element.

11. The distribution device according to claim 8, wherein at least a part of the nozzles of the second group of nozzles comprises a deformable portion, making it possible to adjust the ejection rate and/or the orientation of the ejected flow by deformation of the deformable portion by means of the actuation mechanism.

12. The distribution device according to claim 8, wherein the actuation mechanism comprises a movable grid, positioned so that each of the nozzles comprising a deformable portion is partially inserted into a respective orifice in the grid, the displacement of the grid being capable of modifying the shape of said nozzles and/or their orientation.

13. The distribution device according to claim 1, further comprising an adjustment device for the nozzle outlet pressure of the flow of water ejected by the second group of nozzles, for example an adjusting knob or a multi-position selector.

14. The distribution device according to claim 1, further comprising a selection device making it possible to selectively direct the flow of water entering the distribution device towards the first group of nozzles or towards the second group of nozzles.

15. The distribution device according to claim 14, wherein the selection device also makes it possible to direct the flow of water entering the distribution device simultaneously towards the first and second groups of nozzles.

16. (canceled)

17. The distribution device according to claim 1, wherein the body of the distribution device comprises a third group of nozzles, arranged on the portion of the body forming the gripping handle.

18. The distribution device according to claim 17, further comprising a selection device making it possible to selectively direct the flow of water entering the distribution device towards the first group of nozzles, or towards the second group of nozzles, or towards the third group of nozzles.

19. The distribution device according to claim 1, wherein the body comprises a connection device for connecting the distribution device to a supply line such as a flexible hose.

20. (canceled)

21. The distribution device according to claim 1, further comprising a diffusing device for an encapsulated product, the diffusing device being configured to diffuse a product contained in a capsule into the flow(s) of water ejected by the distribution device, the diffusing device being for example arranged in the head.
